(19) United States
(12) Patent Application Publication
(10) Pub. No.: US 2007/0145334 A1
(43) Pub. Date: Jun. 28, 2007

(54) Volatile corrosion inhibitor and molding material and molded article using the same

(76) Inventors: Nobuyoshi Numbu, Yokkaichi-shi (JP); Kazuhiko Arimatsu, Yokkaichi-shi (JP); Toshimitsu Hamaguchi, Yokkaichi-shi (JP); Tadahiko Nambu, Osaka-shi (JP)

Correspondence Address: BIRCH STEWART KOLASCH & BIRCH, PO BOX 747, FALLS CHURCH, VA, 22040-0747, US

(21) Appl. No.: 10/586,455

(22) PCT Filed: Jan. 17, 2005
(86) PCT No.: PCT/JP05/00805

§ 371 Date: Jul. 18, 2006

(30) Foreign Application Priority Data
Jan. 19, 2004 (JP) 2004-010171

(51) Int. Cl. C09K 3/00; C08K 3/28

(52) U.S. Cl. 252/388; 524/287; 524/428; 524/284

(57) ABSTRACT

A volatile corrosion inhibitor to be kneaded into a resin of the present invention comprises a nitrous acid metal salt, a benzoic acid metal salt, a saturated polycarboxylic acid or a metal salt thereof, and an anticorrosive component for nonferrous metals. The volatile corrosion inhibitor to be kneaded into a resin does not cause melting, gasification, decomposition, vaporization even when exposed to a high temperature condition for molding a thermoplastic resins into an article in a form of films, sheets or fibers. Further, the volatile corrosion inhibitor is free of generation of offensive odor or dust caused by sublimation. As the result, working environment does not deteriorate, and superior anticorrosive ability with respect to nonferrous metal materials such as copper as well as to iron based metal materials is exhibited. In addition, the present invention relates also to a volatile anticorrosive molding material obtained by kneading the volatile corrosion inhibitor into a resin.

### FIELD OF THE INVENTION

The present invention relates to a volatile corrosion inhibitor that exhibits excellent anticorrosive effect to metals when blended to molding materials having thermoplastic resins as a principal composition component, and to a molding material obtained by blending the volatile corrosion inhibitor, and to a volatile corrosion inhibitor molded article using the molding material. A corrosion inhibitor of the present invention is kneaded into, for example, a thermoplastic resin such as polyolefin resin, and then processed into a shape of film, sheet, fiber, or the like by inflation-molding methods, T-die molding methods, melt-spinning methods, or the like, to provide useful volatile anticorrosive products for corrosion prevention of various metal goods.

Especially, the volatile corrosion inhibitor of the present invention has excellent thermal stability, and the molding material and molded the article obtained by blending this volatile corrosion inhibitor exhibit excellent anticorrosive ability even in environment where iron based metal materials represented by steel materials are significantly corroded, and also exhibit excellent anticorrosive ability to nonferrous metal materials of copper, brass, or the like.

### BACKGROUND ART

An anticorrosive film obtained by kneading a volatile corrosion inhibitor into a thermoplastic resin such as polyethylene and polypropylene, and by then being processed into a film form has been known, and an anticorrosive film obtained by application or printing of a volatile corrosion inhibitor has been also known as techniques for preventing discoloration and corrosion of metal goods including iron based metals represented by steels and nonferrous metals such as copper. Such a film is in practical use for mainly packaging of various metal goods.

In corrosion inhibitors used for such a usage, corrosion inhibitors having excellent anticorrosive ability especially with respect to steel materials include dicyclohexyl ammonium nitrite (hereafter abbreviated as DICHAN), sodium nitrite, sodium benzoate, amine salt of organic acid, or the like.

For example, Japanese Unexamined Patent Publication No. Sho 50-10625 and Japanese Unexamined Patent Publication No. 2001-301027 disclose a method in which a volatile corrosion inhibitor such as the above-described DICHAN and sublimable amine is kneaded into a thermoplastic resin and then the resin is formed into a film to provide an anticorrosive film. In these methods, however, there are raised problems that anticorrosive ability of the corrosion inhibitor is reduced by gasification and vaporization or reaction, working environments deteriorate, and furthermore degrade physical properties and appearance as a film, a sheet, or the like. This is because the volatile corrosion inhibitor is usually subjected to heat at high temperatures about 100 to 250° C. in case of extrusion subsequent to kneading with thermoplastic resin, though according also to a kind of thermoplastic resin.

For corrosion prevention of steel materials other than the above-mentioned materials, blending of water-soluble corrosion inhibitor such as nitrite and benzoate into anticorrosive film materials was attempted, but independent use of these corrosion inhibitors hardly exhibits volatile anticorrosive ability. Then, although use in combination of DICHAN or the like has also been studied in order to give volatile anticorrosive function, under coexistence with water-soluble corrosion inhibitors, the volatile corrosion inhibitor will give foaming due to hydrolysis in high temperature conditions by kneading into thermoplastic resin, leading to serious deterioration of physical properties and appearance of the obtained film.

In addition, nitrites such as sodium nitrites and DICHAN having high anticorrosive function with respect to steel materials have a problem that the nitrites promote corrosion of various nonferrous metals including aluminium, zinc, brass, or the like. Then, there have been performed attempts of use in combination of benzotriazol, methylbenzotriazol, or the like that have anticorrosive ability to nonferrous materials. Neither benzotriazol nor methylbenzotriazol causes a problem when kneaded into thermoplastic resin at lower temperature of not more than 90° C., but when they are kneaded into thermoplastic resin together with volatile corrosion inhibitors for steel materials at a higher temperature exceeding approximately 100° C. as mentioned above, they will melt and react with other components to give agglomerated matter, resulting in clogging in a filter portion of an extrusion molding apparatus with the agglomerated matter. Further, the agglomerated matter causes a problem of molding defect in forming for film, sheet, textile, or the like. Furthermore, raised is a problem that heat in molding processing for film form or the like makes the volatile corrosion inhibitors partially vaporize, and fails to fully exhibit anticorrosive effect.

Accordingly, there is demanded development of volatile corrosion inhibitors that do not raise problems such as melting, decomposition, gasification, and vaporization under high temperature conditions in film formation or the like, that do not cause deteriorating of working environments such as offensive odor due to sublimation and generating of dust, and that can exhibit excellent anticorrosive ability not only for steel materials but also for nonferrous metal materials.

The present invention is completed in view of the above-described situations. An object of the present invention is to provide a volatile corrosion inhibitor that do not cause melting, decomposition, gasification, vaporization, or the like even under high temperature condition for forming into a shape of a film or the like, do not deteriorate working environment, and can exhibit excellent anticorrosive ability, even under heated and highly humid condition, to iron based metal materials including steel and even to nonferrous metal materials such as copper and brass by being kneaded to a base material resin. An object of the present invention is also to provide a molding material that gives thermoplastic resin molded articles having volatile anticorrosive ability by blending the corrosion inhibitor, to provide a highly efficient volatile anticorrosive molded article using the molding material, and furthermore to provide an anticorrosion method for metallic materials.

### DISCLOSURE OF THE INVENTION

A volatile corrosion inhibitor to be kneaded into a resin of the present invention to solve the above-described problems is characterized in that,

the volatile corrosion inhibitor is to be blended into a molding material having a thermoplastic resin as a principal base material component; and

the volatile corrosion inhibitor comprises:
a nitrous acid metal salt having a melting point not less than a softening temperature of the thermoplastic resin;
a benzoic acid metal salt;
a saturated polycarboxylic acid or a metal salt thereof; and
an anticorrosive component for nonferrous metals.

The nitrous acid metal salt used in the present invention is preferably at least one selected from a group consisting of an alkali metal salt and an alkaline earth metal salt of nitrous acid. The benzoic acid metal salt is preferably at least one selected from a group consisting of an alkali metal salt and an alkaline earth metal salt of benzoic acid. The saturated polycarboxylic acid is preferably at least one selected from a group consisting of sebacic acid, dodecanedioic acid, adipic acid, fumaric acid, succinic acid, citric acid, tartaric acid, and malic acid, and the preferable metal salt of saturated polycarboxylic acid is an alkali metal salt and/or an alkaline earth metal salt.

Further, preferable anticorrosive component to be blended for anticorrosive function of the above-described nonferrous metals are 2-mercaptobenzothiazole, 2-benzothiazolylthioacetic acid, 3-2-benzothiazolylthiopropionic acid, 2,4,6-trimercapto-s-triazine, 2-dibutylamino-4,6-dimercapto-s-triazine, benzotriazol, methylbenzotriazol, and alkali metal salts, alkaline earth metal salts, zinc salts thereof. These may be used independently, or two or more of them may be used in combination.

In use of benzotriazol or methylbenzotriazol, as mentioned above, when these are kneaded into a thermoplastic resin at a temperature not less than 100° C., they may melt to cause defects. Therefore, in the case of kneading into a thermoplastic resin at a temperature not less than 100° C., metal salt such as Na salt and K salt of benzotriazol and methylbenzotriazol having a melting point of not less than 160° C. are preferably used.

In addition, preferable content ratio of the above-described nitrous acid metal salt, benzoic acid metal salt, saturated polycarboxylic acid or metal salt thereof, and anticorrosive component for nonferrous metals is in ranges of nitrous-acid metal salt: 5 to 50%; benzoic-acid metal salt: 10 to 90%; saturated polycarboxylic acid or metal salt thereof: 1 to 80%; and anticorrosive component for nonferrous metals: 0.1 to 80% in terms of mass ratio existing in all anticorrosive components.

Any kinds of thermoplastic resins to be blended with the above-described volatile corrosion inhibitors of the present invention may be selected according to targeted usages, properties, or the like of molded articles, and polyolefin resins such as polyethylene, polypropylenes, and polybutylene, or copolymerized resins thereof have most advanced practicality in comprehensive consideration of performance, costs, or the like.

Furthermore, the present invention includes a molding material having the above-described volatile corrosion inhibitor by 0.5 to 10 mass % in thermoplastic resins useful for preparation of volatile anticorrosive resin products. Since this molding material gives volatile anticorrosive molded articles in any forms corresponding to usages, by processing into any forms such as a film, a sheet, and a fiber using conventional methods, these volatile anticorrosive molded articles such as film, sheet, textile are also included in a technical scope of the present invention. In addition, when metal materials are inserted and sealed in a container formed with the above-described volatile anticorrosive films or volatile anticorrosive sheets, anticorrosive effect to metal materials may be much more effectively exhibited, and such an anticorrosive packaging method is also included in a scope of the present invention.

### BRIEF DESCRIPTION OF THE DRAWINGS

FIG. 1 is an explanatory view illustrating an anticorrosive examining method adopted in experiment, wherein 1: Metal specimen, 2: Volatile anticorrosive film, 3: Acrylic board, 4: Adhesive.

### BEST MODE FOR CARRYING OUT THE INVENTION

As mentioned above, a volatile corrosion inhibitor of the present invention is a water-soluble solid powder having a high-melting point, free from melting, decomposition, gasification, or the like in a temperature region in being kneaded into thermoplastic resin and then molding at elevated temperatures, and is characterized in combination of at least four components of a nitrous acid metal salt, a benzoic acid metal salt, a saturated polycarboxylic acid or metal salt thereof, and a corrosion inhibitor for nonferrous metals.

The nitrous acid metal salt exhibits excellent anticorrosive ability with respect to iron based metals. Especially, since the nitrous acid metal salt has a function of generating nitrous acid gas that exhibits excellent anticorrosive ability with respect to iron based metals by its decomposition, coupled with existence of the saturated polycarboxylic acid or metal salt thereof described later, in moisture coexisting system due to water, humidity, or the like in atmosphere in acidic range or neutral range, they are most important components for anticorrosive function of iron based metals.

In practical examples of various metal salts, alkali metals such as sodium and potassium, and alkaline earth metals such as calcium and magnesium are most preferable in view of reactivity with moisture in air or humidity or costs, and sodium salts have highest practicality among them.

The benzoic acid metal salt contributes to contact corrosion prevention of iron based metals, and especially under coexistence with the above-mentioned nitrous acid metal salt they synergistically exhibit excellent anticorrosive ability for iron based metal materials. Such function is effectively exhibited by benzoic acid itself, and is similarly exhibited with metal salts of benzoic acid. Preferable metal salts of benzoic acid include alkali metals such as sodium and potassium, and alkaline earth metals such as calcium and magnesium, and sodium salts have most excellent practicality among them.

The above-described saturated carboxylic acid or metal salt thereof has excellent anticorrosive ability in contact areas in independent use to iron based metals, and under coexistence with the nitrous acid metal salt, as mentioned above, they have function of generating a gas with excellent volatile anticorrosive function, serving as most characteristic component in the present invention. As saturated polycarboxylic acid, various saturated carboxylic acids having two or more carboxyl groups in molecule are usable, and preferable examples are sebacic acid, dodecanedioic acid, adipic acid, fumaric acid, succinic acid, citric acid, tartaric acid, malic acid, or the like, and especially preferable examples are sebacic acid, dodecanedioic acid, adipic acid, tartaric acid, or the like. These may be used independently, and two or more kinds of them also may be used in combination, if necessary. Furthermore, metal salts of these acids are similarly effective.

It is known that the nitrous acid metal salt and benzoic acid metal salt have anticorrosive ability with respect to iron based metal materials. However, the present invention makes both of them synergistically exhibit anticorrosive ability by using them in combination. Furthermore the present invention makes these salts exhibit further improvement in contact anticorrosive ability, or exhibit still higher volatile anticorrosive ability by using in combination of saturated polycarboxylic acids or metals salt thereof. Thus, the present invention significantly improves anticorrosive ability of the nitrous acid metal salt and benzoic acid metal salt to iron based metal materials, and at the same time the present invention makes it possible to exhibit outstanding anticorrosive ability also with respect to nonferrous metal materials coupled with the following anticorrosive component for nonferrous metals.

The anticorrosive component for nonferrous metals is indispensable component in order to exhibit anticorrosive effect to nonferrous metals that cannot be attained by the above-described three components, and blending of proper amount of the component makes it possible to give excellent anticorrosive function not only to iron based metals but to nonferrous metal materials such as copper and brass as corrosion inhibitors. In the examples of the anticorrosive component for nonferrous metals, although it is dependent on kinds of target nonferrous metal materials, compounds that exhibit excellent anticorrosive ability in combination with above-mentioned nitrous acid metal salt, benzoic acid metal salt, and saturated polycarboxylic acid or metal salt thereof include 2-mercaptobenzothiazole (hereinafter abbreviated as MBT), 2-benzothiazolylthioacetic acid, 3-2-benzothiazolylthiopropionic acid, 2,4,6-trimercapto-s-triazine, 2-dibutylamino-4,6-dimercapto-s-triazine, benzotriazol, methylbenzotriazol, and alkali metal salt, alkaline earth metal salt, zinc salt thereof. These may be used independently, and two or more kinds of them also may be used in combination, if necessary.

In an corrosion inhibitor of the present invention having the above-described four components as essential components, the amount of blending of the nitrous acid metal salt is preferably not less than 5 mass % and not more than 50 mass %. On one hand, especially an amount of blending of less than 5 mass % gives insufficient anticorrosive ability to iron based metal materials, and on the other hand, the salt in an amount of blending exceeding 50 mass % corresponds to combustible solid in dangerous substance, and disadvantageously restrictions should be applied in handling. More preferable amount of blending of the nitrous acid metal salt is not less than 10 mass %, and not more than 30 mass %.

The amount of blending of benzoic acid metal salt is preferably not less than 10 mass %, and not more than 90 mass %. An amount of blending of less than 10 mass % gives a relatively excessive amount of nitrites, and, as a result, it corresponds disadvantageously for combustible solid. On the contrary, an amount of blending exceeding 90 mass % disadvantageously does not provide necessary amount of blending of other anticorrosive components. More preferable amount of blending of the benzoic acid metal salt is not less than 20 mass %, and is not more than 80 mass %.

The amount of blending of saturated polycarboxylic acid or metal salt thereof is preferably not less than 1 mass %, and is not more than 80 mass % in a percentage occupied in all of the corrosion inhibitor components. Less than 1 mass % of the amount of blending exhibits only unsatisfactory anticorrosive ability to iron based metal materials, and conversely, an amount of blending exceeding 80 mass % disadvantageously does not provide necessary amount of blending of other anticorrosive components. More preferable amount of blending of the saturated polycarboxylic acid or metal salt thereof is not less than 2 mass %, and not more than 50 mass %.

The amount of blending of the anticorrosive component for nonferrous metals is preferably not less than 0.1 mass %, and not more 80 mass %, in a percentage occupied in all of the corrosion inhibitor components. Less than 0.1 mass % of amount of blending tends to give unsatisfactory anticorrosive ability to nonferrous metal materials, and an excessive amount of blending exceeding 80 mass parts disadvantageously makes difficult reservation of an amount of blending of other proper anticorrosive components. More preferable amount of blending of anticorrosive component for nonferrous metals is not less than 0.5 mass %, and not more than 50 mass %.

The corrosion inhibitor of the present invention has the above-described four components as essential components, and for example, a proper amount of lubricant and inorganic particle such as silica and alumina, plasticizer, antioxidant, ultraviolet ray absorbent, antistatic agent, flame resistant agent, colorant, antifungal agent, or the like may be blended in addition to the components according to usages and objects.

The amount of blending of the corrosion inhibitor of the present invention into the thermoplastic resin is preferably not less than 0.5 mass %, and not more than 10 mass %. Especially an amount of blending of less than 0.5 mass % tends to provide unsatisfactory anticorrosive ability with respect to iron based metals. Anticorrosive effect is saturated with an amount of blending of about 10 mass %, and furthermore an amount of blending not less than the value will disadvantageously cause problems of degradation of strength and appearance such as transparency, of films, sheets, textiles, or the like.

The corrosion inhibitor of the present invention is usually provided in a state of powder as a mixture including four of the above-described indispensable components and the other components to be blended by necessity. The inhibitor may be provided in a form of grain, flake, tablet, or the like in order to improve convenience in transportation and handling including prevention of scattering at the time of handling or the like. The inhibitor may also be provided in a form of pellet, grain, flake, and block for molding material as a masterbatch mixed in a thermoplastic resin material to be blended thereinto with a higher concentration.

In blending of the corrosion inhibitor to the thermoplastic resin, used is a method that a powder of the corrosion inhibitor (kneaded material) obtained by being pulverized into not more than about 100 μm is preferably kneaded using arbitrary methods into a form of pellet, grain, powder, or the like of thermoplastic resins, and then obtained is a compound with a Banbury mixer, a roll mill, a kneader, a biaxial extruder, or the like, or that after the pellet, grain, powders, or the like and the corrosion inhibitor are directly blended, they are introduced into a molding machine.

As thermoplastic resin to which the volatile corrosion inhibitor is to be blended, low density polyethylene, medium density polyethylene, high density polyethylene, polypropylene, and the other polyolefin resins, as well as polyolefine copolymerized resins are most suitable. In addition to the above-mentioned resins, various thermoplastic resins such as polyester resin, polyamido resin, copolymers such as ethylene-vinyl acetate and ethylene-acrylic ester, ionomer resin, polyvinyl chloride, polyvinyl alcohol, or the like may be used.

Molding methods using the molding material of the thermoplastic resins including the volatile corrosion inhibitor is not especially limited, and publicly known molding methods, for example, an inflation process, a T-die method, or the like as methods for film formation; a T-die method or the like as a method to form a sheet; a melting extrusion method as a method to form fiber may suitably be adopted. When a form of a fiber is obtained, various anticorrosive products such as cottony state, or nonwoven fabric state, net shape, and still more arbitrary-shaped woven or knitted fabrics may be obtained according to subsequent usages and purposes.

Accordingly, molded articles including a proper amount of the volatile corrosion inhibitor in a shape of film, sheet, and fiber are processed into arbitrary shapes such as a bag, a wrapping paper, and a box, and then are used for wrapping of various metal goods. Thus, corrosion in storage or in transportation of the metal goods concerned will be controlled as much as possible.

Alternatively, enclosure as piece of a sheet and a fabric piece into a container of metal goods can also exhibit anticorrosive ability. Further, just inserting of a volatile anticorrosive molded article of the present invention inside of the product concerned under transportation or storage can achieve anticorrosive function for metal goods that especially need corrosion prevention of inner walls like various reaction or treatment containers. Furthermore, injection molding of thermoplastic resin such as polyethylene and polypropylene including the volatile corrosion inhibitor of the present invention kneaded therein will allow manufacturing of airtight containers in various shapes. Corrosion prevention can easily be attained by sealing and packaging using arbitrary methods such as heat sealing, after metal goods are stored in this container or metal goods are inserted therein.

In a volatile corrosion inhibitor of the present invention, as mentioned above, the saturated polycarboxylic acid or metal salt thereof is blended into the nitrous acid metal salt and the benzoic acid metal salt. Therefore, they react gradually with nitrites under existence of moisture and humidity to generate nitrous acid gas that is effective in corrosion prevention of iron based metal materials, exhibiting high anticorrosive effect also in a non-contact gas phase area in addition in an area contacted with respect to iron based metal materials. In addition, use in combination with an anticorrosive component for nonferrous metal materials such as copper and brass allows demonstration of multiplicatively excellent anticorrosive ability not only to nonferrous metal materials but to iron based metal materials.

### EXAMPLE

The present invention will, hereinafter, be described in more detail with reference to Examples. The present invention is not intended to be limited by following Examples. The present invention may be performed with suitable alterations in a range adapted to spirit of the present invention described the above and below, and they are to be included in a technical scope of the present invention.

Components used in the following Examples and Comparative examples will be given in the following.

Component (A): Sodium nitrite, manufactured by Nissan Chemical Industries, Ltd. under the trade name of “Nitrite soda”

Component (B): Sodium sebacate, manufactured by HOKOKU CORP. under the trade name of “SA-NA”

Component (C): Sodium benzoate, manufactured by FUSHIMI Pharmaceutical Co., Ltd. under the trade name of “Fuminal”

Component (D): 2-mercaptobenzothiazole (MBT), SANSHIN CHEMICAL INDUTRY under the trade name of “Sanselar M”

### Examples and Comparative Examples

As Examples and Comparative examples, corrosion inhibitor powders were composed in accordance with recipes illustrated in Table 1 and Table 2, and then were ground into mean particle diameters of not more than 75 μm. These were added to a low density polyethylene resin powder (manufactured by Sumitomo Seika Chemicals Co., Ltd. under the trade name of “Fluothane G401-N”) at the rate of 2 mass %. The mixture was homogenously blended to obtain molding materials. The molding materials were molded into volatile anticorrosive films having a thickness of 100 μm at a temperature of 150 to 160° C. by an inflation process. In all cases, generation of odor and dust, and the other pollution of environment were not observed.

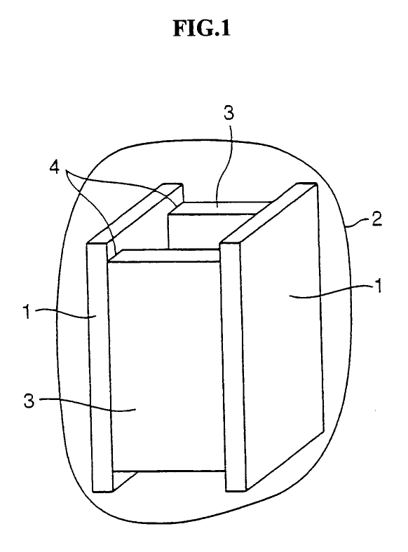

Each volatile anticorrosive film obtained by the above and each specimen consisting of iron, steel, or brass (60×80×1.2 mm) are assembled as FIG. 1. In FIG. 1, referential notation 1 represents a metal specimen, referential notation 2 a volatile anticorrosive film, referential notation 3 an acrylic board, and referential notation 4 an adhesive. The same kind of specimens of two sheets and two sheets of acrylic resin (30×60×5 mm) were bonded with an instantaneous adhesive (trade name: “ARON α” manufactured by Toagosei Co., Ltd.) so as to give contacting areas and gaseous phase areas in non-contact state, to form a box as FIG. 1. The interval between specimens was 30 mm. The boxes were packed with the film and heat-sealed, and the anticorrosive abilities were evaluated in humidified atmosphere (49±1° C. and not less than RH 95%) under following criteria. Table 3 illustrates the results.

In examination, corrosion state of each specimen was evaluated under following criteria in contact areas and non-contact areas between films and metal specimens after one-month progress in the above-described warmed and humidified atmosphere.

very good: corrosion and discoloration were not observed;

good: dotted corrosion and slight discoloration were observed;

average: clear corrosion or discoloration was observed in less than 10% of area in total surface area of metal specimen;

poor: corrosion or discoloration was observed in 10 to 50% of a range in total surface area of metal specimen; and

very poor: corrosion or discoloration was observed to more than 50% of area in total surface area of metal specimen.

In film physical property,

good: processing could be performed without any trouble in film-formation with inflation process as mentioned above, and film physical property was good;

average: although processing into a film shape was possible, the film appearance had slight defect; and

poor: film formation was difficult and a uniform film was hardly obtained.

TABLE 1

| | | | | | | (mass %) | |
|---|---|---|---|---|---|---|---|
| | Notation | | | | | | |
| | 1 | 2 | 3 | 4 | 5 | 6 | 7 |
| Sodium nitrite | 25 | 25 | 25 | 25 | 25 | 70 | 5 |
| Sodium benzoate | 60 | 60 | 60 | 60 | 60 | 15 | 80 |
| Sodium sebacate | 10 | 10 | 10 | 10 | 10 | 10 | 10 |
| 2-Mercaptobenzothiazole | 5 | — | — | — | — | 5 | 5 |
| Sodium salt of 2-mercaptobenzo- | — | 5 | — | — | — | — | — |
| thiazole | | | | | | | |
| 3-2-Benzothiazolylthiopropionic | — | — | 5 | — | — | — | — |
| acid | | | | | | | |
| 2,4,6-Trimercapto-s-triazine | — | — | — | 5 | — | — | — |
| Sodium salt of benzotriazol | — | — | — | — | 5 | — | — |

TABLE 2

| | | | | | | | | (mass %) | |
|---|---|---|---|---|---|---|---|---|---|
| | Notation | | | | | | | | |
| | 8 | 9 | 10 | 11 | 12 | 13 | 14 | 15 | 16 |
| Sodium nitrite | 25 | 25 | 25 | 25 | 25 | 25 | 25 | 2 | — |
| Sodium benzoate | 75 | 72 | 65 | 60 | 60 | 55 | 64.95 | 88 | — |
| Sodium sebacate | — | — | 10 | 10 | 10 | 10 | 10 | 10 | — |
| Potassium hydrogen | — | 3 | — | — | — | — | — | — | — |
| tartrate | | | | | | | | | |
| Benzotriazole | — | — | — | 5 | — | 5 | — | — | — |
| Methylbenzotriazol | — | — | — | — | 5 | 5 | — | — | — |
| 2-mercaptobenzo- | — | — | — | — | — | — | 0.05 | — | — |
| thiazole | | | | | | | | | |
| Benzoate of cyclo- | — | — | — | — | — | — | — | — | 100 |
| hexylamine | | | | | | | | | |

TABLE 3

| | Kind of specimen | | | | | | | Generation | |
|---|---|---|---|---|---|---|---|---|---|
| | Steel plate | | | | Brass plate | | | amount of | |
| | | Non- | Copper plate | | | Non- | Corrosion | nitrous acid | |
| Example of | Contacted | contacted | Contacted | Non- | Contacted | contacted | inhibitor | gas | |
| examination | area | area | area | contacted | area | area | pH (1%) | (μg/10 ml) | Film property |
| Notation 1 | very good | very good | very good | good | good | good | 7.1 | 24.5 | good |
| Notation 2 | very good | very good | good | good | good | good | 9.6 | 24.4 | good |
| Notation 3 | very good | very good | very good | good | good | good | 7.4 | 23.8 | good |
| Notation 4 | very good | very good | very good | good | good | good | 7.4 | 23.6 | good |
| Notation 5 | very good | very good | very good | good | very good | good | 9.6 | 24.7 | good |
| Notation 6 | very good | very good | good | good | good | good | 7.4 | 86.2 | good |
| Notation 7 | very good | very good | very good | good | very good | good | 7.1 | 9.7 | good |
| Notation 8 | average | average | very poor | average | very poor | average | 9.4 | 3.9 | good |
| Notation 9 | average | very good | very poor | very poor | very poor | poor | 5.7 | 170.3 | good |
| Notation 10 | good | very good | very poor | poor | very poor | poor | 9.4 | 24.2 | good |
| Notation 11 | very good | good | very good | good | very good | average | 7.2 | 28.1 | poor |
| Notation 12 | good | good | good | average | very good | average | 7.2 | 27.3 | poor |
| Notation 13 | very good | very good | very good | good | very good | good | 7 | 31.7 | poor |
| Notation 14 | good | good | poor | poor | poor | poor | 9.2 | 24.5 | good |
| Notation 15 | poor | average | poor | average | poor | average | 9 | 4.4 | good |
| Notation 16 | poor | good | average | average | average | average | — | — | average |
| Notation 17 | good | good | poor | average | very poor | average | — | — | — |
| Notation 18 | good | good | average | average | average | average | — | — | — |
| Notation 19 | poor | poor | poor | poor | poor | poor | — | — | — |
| Notation 20 | poor | very good | poor | good | poor | good | 7.1 | 24.5 | — |

Notation 17: Nitrite based anticorrosive film manufactured by a domestic company A, 105 μm in thickness
Notation 18: Nitrite based anticorrosive film manufactured by an overseas company B, 105 μm in thickness
Notation 19: Polyethylene film including a commercially available corrosion inhibitor added therein, 100 μm in thickness
Notation 20: Polyethylene film (100 μm in thickness) without a corrosion inhibitor was used for package, and a film having a size of 100 cm² of notation 1 folded was inserted in with metal specimen.

Results of the above-described Tables 1 to 3 give following analyses.

Corrosion inhibitors of notations 1 to 7 that satisfy all preferable requirements for the present invention do not give generation of corrosion in any of a contacted area of steel materials and films and non-contact gas phase areas, and have apparently high anticorrosive effect also with respect to copper as a nonferrous metal material.

On the other hand, notation 8 that does not include a saturated polycarboxylic acid and an anticorrosive component for non-corrosion metals gives severe discoloration and unsatisfactory anticorrosive ability for all of iron material, copper and brass. In addition, notations 9 and 10 obtained by adding a saturated polycarboxylic acid to the notation 8 give excellent anticorrosive ability for an iron material especially in a gas phase area, but give severe discoloration and hardly exhibit anticorrosive ability for nonferrous metal material of both of copper and brass.

Since notations 11 to 13 were molded at high temperatures compared with melting points of anticorrosive component for nonferrous metals, other components gave clogging in an extrusion molding section at filters in film formation. Therefore, although stable molding of film-form products was difficult, excellent results were obtained in anticorrosive examination using portions partially formed. In addition, notation 14 having a less amount of addition than in a preferable range of the anticorrosive component for copper gave poor anticorrosive ability to copper and brass.

Notation 15 having a less amount of addition of the nitrous acid metal salt than in a preferable range exhibited insufficient anticorrosive effect with respect to steel, and also exhibited insufficient anticorrosive effect to copper and brass probably because of a little gas of vaporized nitrous acid. In addition, notation 16 including a benzoate of organic amine made the corrosion inhibitor vaporized in molding into a shape of a film and generated white smoke, and not only working environment was seriously impaired, but also exhibited inferior anticorrosive effect in contact area to steel, copper and brass.

Notations 17 and 18 are anticorrosive films obtained by blending commercial nitrite corrosion inhibitors, and they exhibited inferior anticorrosive effect with respect to copper and brass, though had anticorrosive effect to steel to some extent.

Notation 19 is a blank material using a film consisting of only polyethylene, and anticorrosive effect was naturally not obtained at all. Notation 20 is an example in which 100 cm² of the volatile anticorrosive film used in notation 1 was inserted in a folded state inside of a polyethylene film. Although corrosion was recognized in a contacted area with the polyethylene film, gaseous phase anticorrosive effect was exhibited and corrosion was not recognized in a non-contact area.

A Volume of Vaporized Nitrous Acid Gas and a pH of Aqueous Solution

The volumes of nitrous acid gas vaporized from the powders of corrosion inhibitors used in the notations 1 to 13 were measured. Measurement was performed by a following method. Samples of each 0.5 g of corrosion inhibitors were taken in a beaker having a 100 ml by volume, and the beaker was introduced in a desiccator having 17 liters of volume. A weighing bottle having 40 mm of diameter containing 10 ml of 35% glycerol water was introduced in the desiccator to adjust an atmosphere in the desiccator 90% of humidity. The desiccator was maintained in this condition for 24 hours. An amount of nitrous acid that had been absorbed by 10 ml of 35% glycerol water (μg/10 ml) after 24 hours was determined from an absorbance by a method of ultraviolet radiation spectroscope using 1-naphthylamine. Table 3 shows the results.

In addition, the pH value of each corrosion inhibitor powder diluted with ion exchange water to 1% was measured. Table 3 shows the results. In case of notations 1, 3, 4, 6, 7, 11, 12, 13 and 14, a part of anticorrosive components was suspended in water.

From results of the above-described experiments, notation 8 having only a nitrous acid metal salt and a benzoic acid metal salt in combination gave a small amount of vaporized nitrous acid gas volume. In case of notation 9 to which potassium hydrogen tartrate was added, since double decomposition under acidic condition generated a large amount of vaporized gas, a large amount of generation of vaporized nitrous acid gas was observed. However, although mechanism of generation was yet unknown, notations 1 to 6 and notations 10 to 14 having alkaline saturated polycarboxylic acid blended therein gave generation of considerably large amount of vaporized gas. DICHAN as a typical corrosion inhibitor having a high volatile anticorrosive effect with respect to steels gave vaporized nitrous acid gas volume of approximately 10 (μg/10 ml) by this measuring method. It was clarified that excellent anticorrosive effect with respect to steels can be obtained by using in combination of a nitrous acid metal salt and a saturated polycarboxylic acids or metal salt thereof.

The above-described examples represent cases where a volatile corrosion inhibitor was kneaded with a thermoplastic resin, and the mixture was processed in a shape of a film. Similar function may be expected in a case of molded articles processed into a shape of a sheet. The sheet has preferably a shape of a wavy plate having a larger surface area and the like. Furthermore, same anticorrosive ability may also be expected in a case of processed fiber to obtain a nonwoven fabric state, or woven or knitted fabrics.

### INDUSTRIAL APPLICABILITY

A volatile corrosion inhibitor according to the present invention does not cause melting, gasification, decomposition, vaporization even when exposed to a high temperature condition for molding a thermoplastic resins into an article in a form of films, sheets, or fibers. Further, the volatile corrosion inhibitor is free of generation of offensive odor or dust caused by sublimation. As the result, working environment does not deteriorate and volatile anticorrosive molded articles having stable quality can be obtained. In addition, since a saturated polycarboxylic acid or metal salt thereof and a nitrite component included in the corrosion inhibitor of the present invention react with moisture in atmosphere to generate nitrous acid gas, anticorrosive components will adsorb onto a surface of metals also in areas without in direct contact with an anticorrosive film or the like to form a same passive state coating as in an area in direct contact with the anticorrosive film or the like, exhibiting anticorrosive ability. Furthermore, blending of anticorrosive components having anticorrosive ability with respect to nonferrous metal materials enables effective practical use in corrosion prevention of nonferrous metal materials, leading to greatly improved corrosion prevention performance for iron based metal materials, such as iron materials.

1-13. (canceled)

14. A volatile corrosion inhibitor to be kneaded into a resin,
wherein the volatile corrosion inhibitor is to be blended into a molding material having a thermoplastic resin as a principal base material component; and
comprising:
a nitrous acid metal salt having a melting point not less than a softening temperature of the thermoplastic resin;
a benzoic acid metal salt;
a saturated polycarboxylic acid or a metal salt thereof; and
an anticorrosive component for nonferrous metals.

15. The volatile corrosion inhibitor according to claim 14, wherein the nitrous acid metal salt is at least one selected from a group consisting of an alkali metal salt and an alkaline earth metal salt of nitrous acid.

16. The volatile corrosion inhibitor according to claim 14, wherein the benzoic acid metal salt is at least one selected from a group consisting of an alkali metal salt and an alkaline earth metal salt of benzoic acid.

17. The volatile corrosion inhibitor according to claim 14, wherein the saturated polycarboxylic acid is at least one selected from a group consisting of sebacic acid, dodecanedioic acid, adipic acid, fumaric acid, succinic acid, citric acid, tartaric acid, and malic acid.

18. The volatile corrosion inhibitor according to claim 14, wherein the metal salt of the saturated polycarboxylic acid is at least one selected from a group consisting of an alkali metal salt and an alkaline earth metal salt.

19. The volatile corrosion inhibitor according to claim 14, wherein the anticorrosive component for nonferrous metals is at least one selected from a group consisting of 2-mercaptobenzothiazole, 2-benzothiazolylthioacetic acid, 3-2-benzothiazolylthiopropionic acid, 2,4,6-trimercapto-s-triazine, 2-dibutylamino-4,6-dimercapto-s-triazine, benzotriazol, methylbenzotriazol, and alkali metal salt, alkaline earth metal salt, zinc salt thereof.

20. The volatile corrosion inhibitor according to claim 14, wherein:
the nitrous acid metal salt is at least one selected from a group consisting of an alkali metal salt and an alkaline earth metal salt of nitrous acid;
the benzoic acid metal salt is at least one selected from a group consisting of an alkali metal salt and an alkaline earth metal salt of benzoic acid;
the saturated polycarboxylic acid is at least one selected from a group consisting of sebacic acid, dodecanedioic acid, adipic acid, fumaric acid, succinic acid, citric acid, tartaric acid, and malic acid;
the anticorrosive component for nonferrous metals is at least one selected from a group consisting of 2-mercaptobenzothiazole, 2-benzothiazolylthioacetic acid, 3-2-benzothiazolylthiopropionic acid, 2,4,6-trimercapto-s-triazine, 2-dibutylamino-4,6-dimercapto-s-triazine, benzotriazol, methylbenzotriazol, and alkali metal salt, alkaline earth metal salt, zinc salt thereof.

21. The volatile corrosion inhibitor according to claim 20, wherein the metal salt of the saturated polycarboxylic acid is at least one selected from a group consisting of an alkali metal salt and an alkaline earth metal salt.

22. The volatile corrosion inhibitor according to claim 14, comprising the nitrous acid metal salt, the benzoic acid metal salt, the saturated polycarboxylic acid or the metal salt thereof, and the anticorrosive component for nonferrous metals at a mass ratio of 5 to 50:10 to 90:1 to 80:0.1 to 80, respectively.

23. The volatile corrosion inhibitor according to claim 14, wherein the thermoplastic resin includes a polyolefin resin as a principal component.

24. A molding material for preparation of a volatile anticorrosive resin product, wherein 0.5 to 10 mass % of the volatile corrosion inhibitor according to claim 14 is included in a thermoplastic resin.

25. A volatile anticorrosive film obtained by molding the molding material according to claim 24 into a shape of a film.

26. The volatile anticorrosive sheet obtained by molding the molding material according to claim 24 into a shape of a sheet.

27. A volatile anticorrosive fiber obtained by molding the molding material according to claim 24 into a shape of a fiber.

28. An anticorrosion method of a metal material, comprising the steps of:
molding a container with the volatile anticorrosive film or with the volatile anticorrosive sheet according to claim 25;
inserting the metal material into the container; and
sealing the container for packaging.

29. An anticorrosion method of a metal material, comprising the steps of:
molding a container with the volatile anticorrosive film or with the volatile anticorrosive sheet according to claim 26;
inserting the metal material into the container; and
sealing the container for packaging.
